(19) United States
(12) Patent Application Publication
(10) Pub. No.: US 2026/0248324 A1
(43) Pub. Date: Aug. 27, 2026

(54) CHIMNEY APPARATUS

(71) Applicants: Riki Franco, New York, NY (US); Oron Franco, New York, NY (US)

(72) Inventors: Riki Franco, New York, NY (US); Oron Franco, New York, NY (US)

(21) Appl. No.: 19/059,341

(22) Filed: Feb. 21, 2025

(51) Int. Cl. A47J 37/07; F23Q 13/04

(52) U.S. Cl. CPC A47J 37/079; F23Q 13/04

(57) ABSTRACT

A chimney starter kit including starter material and a charcoal supply retained in a chimney apparatus. The chimney apparatus may include a housing with at least one side wall forming a chamber, an opening bordering the perimeter edge, and a base plate positioned opposite the opening. A support structure is connected to the outer wall surface, and a first handle is hingedly pivotal at a fulcrum point. A barrier element is disposed on the support structure, contributing to stability and structural integrity. The housing may be hexagonal, with multiple openings in the side wall to facilitate airflow. A second handle, oriented perpendicular to the first handle, is also hingedly pivotal and connected to a mounting structure affixed to the barrier element. The base plate includes bores to enhance ventilation, while beveled edges on the barrier element provide ergonomic handling and durability.

### FIELD OF THE EMBODIMENTS

The field of the invention and its embodiments relates to a chimney starter kit, configured for igniting charcoal by facilitating an airflow system. In particular, the chimney starter kit includes starter material and a charcoal supply retained in a chimney apparatus having a housing with one or more openings that enhance airflow for improved combustion.

### BACKGROUND OF THE EMBODIMENTS

In today's market, consumers are increasingly looking for products that offer greater convenience, ease of use, and time-saving solutions. Many individuals are seeking ways to reduce the effort and complexity associated with setting up traditional grilling or heating systems, often preferring bundled products that streamline the process. As a result, there is growing demand for innovative solutions that address these needs, providing integrated systems that simplify preparation, ensure better organization, and improve the overall user experience. Moreover, with more diverse product designs entering the market, it is essential for products to offer versatility and compatibility with various configurations to appeal to a wider audience.

The current market for charcoal chimney starters presents many configuration limitations that affect efficiency, safety, and usability. Traditional chimney starters often suffer from inefficient ignition due to inadequate airflow, resulting in prolonged startup times and uneven burning of charcoal. Many existing models lack ventilation openings, leading to restricted oxygen flow and excessive smoke production, which negatively impacts combustion efficiency. Additionally, safety concerns arise from the manual handling required to transfer ignited charcoal. Conventional configurations necessitate tilting the entire chimney starter to pour out hot coals, increasing the risk of accidental spills and burns. Furthermore, many models feature handles that become excessively hot during use, requiring additional protective gear for safe handling.

Traditional charcoal chimney starters typically feature a single handle, which can make it difficult to control the pouring motion when transferring hot, ignited charcoal to a grill or fire pit. The lack of stability during this process increases the risk of accidental spills, which can lead to burns, fire hazards, and uneven charcoal distribution. Additionally, gripping and tilting a fully loaded chimney starter with one hand can be physically demanding, particularly for users with limited hand strength or dexterity. Without a controlled dumping mechanism, users have limited precision when transferring hot coals, leading to potential safety hazards and inefficient fuel distribution.

### SUMMARY OF THE EMBODIMENTS

The present invention and its embodiments relate to a chimney starter kit including starter material and a charcoal supply retained in a chimney apparatus. In an embodiment, the chimney apparatus may be configured with a dual-handle configuration. Implementing two handles in a charcoal chimney starter addresses multiple ergonomic, safety, and operational challenges present in conventional single-handle configurations. The chimney apparatus addresses many of these shortcomings by incorporating an optimized airflow system with one or more placed openings to enhance combustion efficiency. By incorporating a second, hingedly pivotal handle oriented perpendicular to the primary handle, the user gains greater control over the tipping motion. The secondary handle allows for a two-handed grip, improving balance and stability while pouring. This configuration reduces strain on the wrist and forearm, enhances precision in directing the hot coals, and minimizes the risk of accidental spills. Furthermore, the pivoting nature of the second handle enables a controlled tilting mechanism, allowing the user to regulate the pouring angle more effectively. Overall, a dual-handle configuration improves safety, usability, and efficiency by providing a more controlled, ergonomic, and user-friendly solution for handling and transferring hot charcoal.

### BRIEF DESCRIPTION OF THE DRAWINGS

The present disclosure may be better understood and its numerous features and advantages made apparent to those skilled in the art by referencing the accompanying drawings. The use of the same reference symbols in different drawings indicates similar or identical items.

FIG. 1 depicts a rear perspective view of the chimney apparatus with a first handle oriented perpendicular to a second handle, the first handle and the second handle are oriented in a first hingedly pivotal position during use according to at least some embodiments described herein.

FIG. 2 depicts a rear perspective view of the chimney apparatus of FIG. 1 in which the first handle and the second handle are oriented in a second hingedly pivotal position during storage according to at least some embodiments described herein.

FIG. 3 depicts a top perspective view of the chimney apparatus of FIG. 1 showing the chamber of the housing and the base plate with a plurality of openings located thereon according to at least some embodiments described herein.

FIG. 4 depicts a top perspective view of the chimney starter kit including starter material and a charcoal supply retained in the chimney apparatus of FIG. 1 showing the chamber of the housing retaining a container of charcoal with the first handle and the second handle being oriented in a first hingedly pivotal position during use according to at least some embodiments described herein.

### DESCRIPTION OF THE PREFERRED EMBODIMENTS

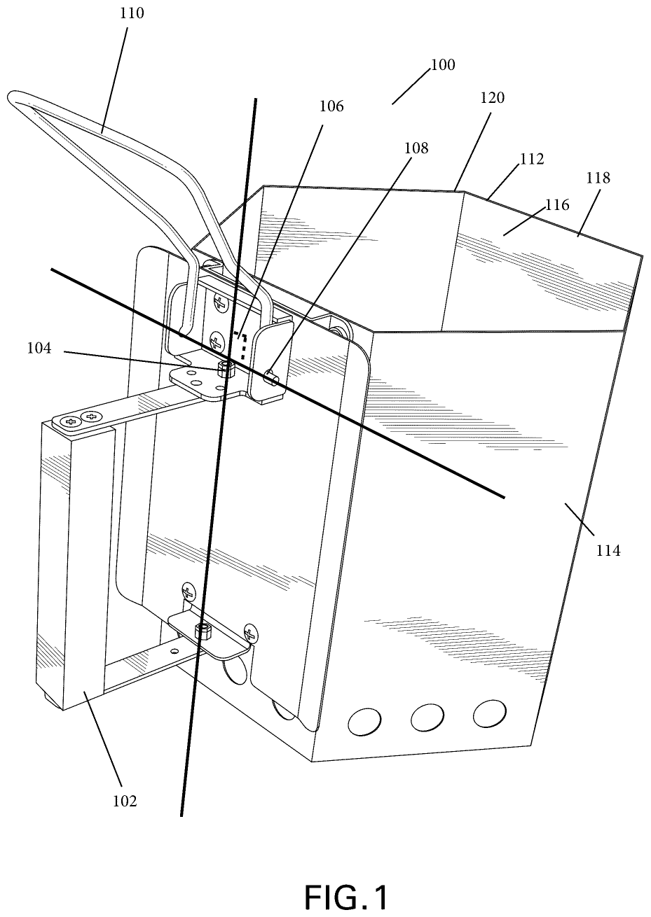

FIGS. 1-4 illustrate example configurations of a chimney starter kit including starter material and a charcoal supply retained in a chimney apparatus configured to facilitate the ignition and transfer of charcoal in a controlled and efficient manner. The apparatus comprises a housing with at least one side wall that forms a chamber, wherein the housing includes an opening along its perimeter edge and a base plate positioned opposite the opening. The housing structure is configured to enhance airflow dynamics, promoting efficient combustion by allowing optimal oxygen circulation.

The chimney apparatus further incorporates a support structure affixed to the outer wall surface of the housing, providing stability and structural reinforcement. A first handle is hingedly pivotal at a fulcrum point, enabling controlled tilting and maneuverability during operation. Additionally, a barrier element with a plate is disposed along the support structure to enhance durability and facilitate secure handling. In one embodiment, the housing is hexagonal in shape, contributing to a balanced and space-efficient design. The apparatus may further include a second handle that is also hingedly pivotal, oriented perpendicular to the first handle, allowing for improved control when pouring ignited charcoal. The inclusion of one or more placed bores in the base plate and multiple openings in the side walls optimizes airflow, thereby accelerating the ignition process. The configuration of beveled edges on the barrier element further enhances structural integrity and handling precision, ensuring safe and efficient use.

FIG. 1 depicts a chimney apparatus 100 with a first handle 102 having a first fulcrum point 104 oriented perpendicular 106 to a second fulcrum point 108 of a second handle 110. The first handle 102 and the second handle 110 are oriented in a first hingedly pivotal position during use.

The chimney apparatus 100 has a housing 112 having at least one side wall 114 forming a chamber 116. The housing 112 has an opening 118 bordering an outer perimeter edge 120 of the chamber 116.

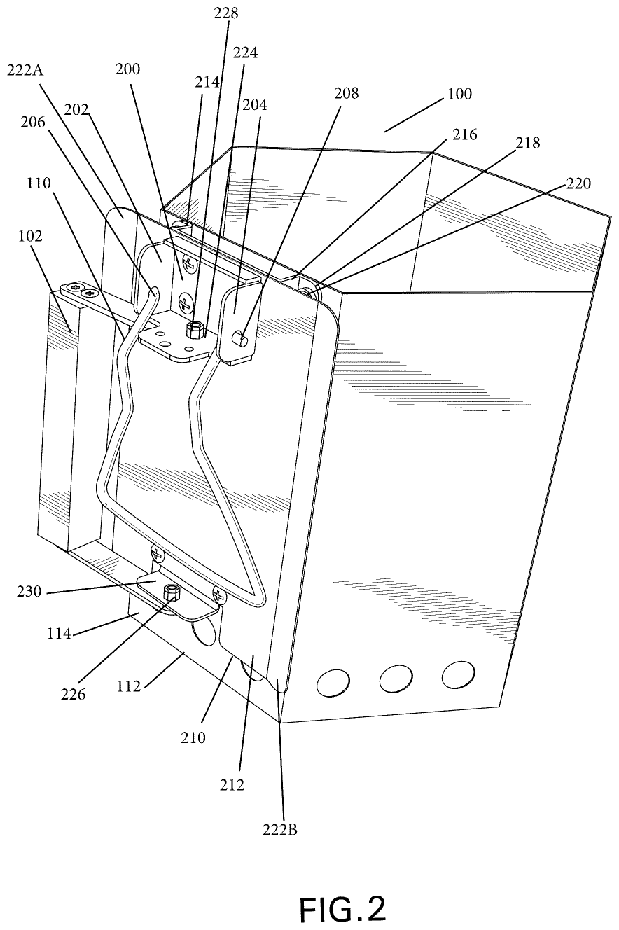

FIG. 2 depicts the chimney apparatus 100 of FIG. 1 in which the first handle 102 and the second handle 110 are oriented in a second hingedly pivotal position during storage and/or when the handle is not needed to be grasped by a user. The second handle 110 may partially overlay and/or be disposed over at least a portion of first handle 102 when in this closed position. The first handle 102 and the second handle 110 are both connected to a mounting structure 200. The mounting structure 200 has a first mounting plate 202 located opposite a second mounting plate 204. The second handle 110 has a first fulcrum point 206 located at the first mounting plate 202 and a second fulcrum point 208 located at the second mounting plate 204. In an embodiment, the chimney apparatus 100 may have the housing 112 being substantially hexagonal in shape. The housing 112 may be a cylindrical shape and/or any shape capable of retaining a container of a charcoal supply and/or starter material. The first handle 102 protrudes from the outer wall surface of the at least one side wall of the housing 112.

The mounting structure 200 has a third mounting plate 224 oriented perpendicular the first mounting plate 202 and second mounting plate 204. The first handle 102 has a first fulcrum point 226 located at an L-bracket 230 extending from a portion of a barrier element 210 and a second fulcrum point 228 located at the third mounting plate 224. The barrier element 210 comprising a plate 212 is disposed at a surface of a support structure 214. The support structure 214 is connected to an outer wall surface of the at least one side wall 114 of the housing 112. The support structure 214 has a stepped portion 216 and a substantially L-shaped flange 218 connected to the at least one side wall 114 of the housing 112 with a fastener 220 such as a screw and/or a nut and bolt. The plate 212 of the barrier element 210 may have one or more beveled edges. A first beveled edge 222A of the one or more beveled edges extends beyond an outer perimeter edge of the support structure 214. A second beveled edge 222B of the one or more beveled edges is located opposite the first beveled edge 222A. The barrier element 210 may form a barrier between a heat source and a user's hands.

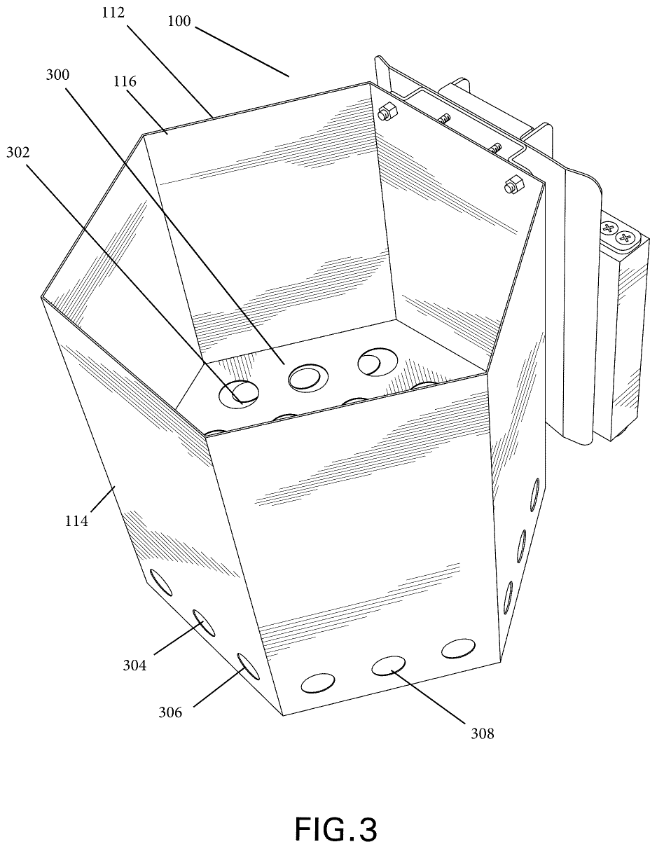

FIG. 3 depicts the chimney apparatus 100 of FIG. 1 showing the chamber 116 of the housing 112. The housing 112 has a base plate 300 with one or more bores 302 located thereon. The one or more bores 302 of the base plate 300 are oriented perpendicular to one or more openings 304 located through a portion of the at least one side wall 114 of the housing 112. In an embodiment a first opening 306 of the one or more openings 304 may be in coplanar alignment with a second opening 308 of the one or more openings 304 to facilitate an airflow with superior circulation.

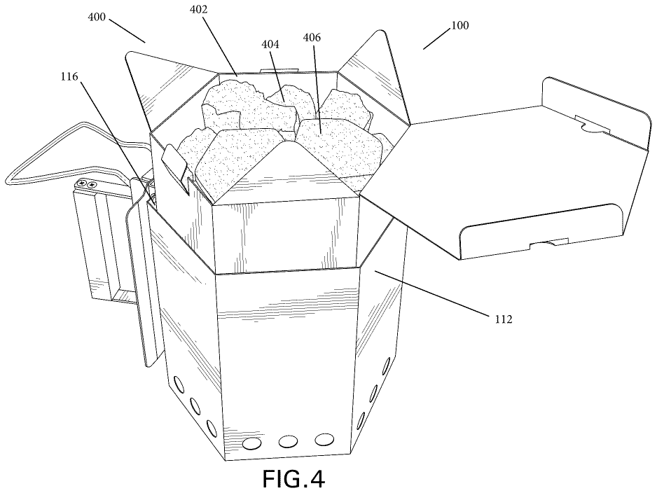

FIG. 4 depicts a top perspective view of a charcoal chimney starter kit 400 including starter material 404 and a charcoal supply 406 retained in a container 402. The container 402 is retained in the chamber 116 of the housing 112 of the chimney apparatus 100 of FIG. 1. A charcoal supply and starter material may be integrated into the chimney apparatus for convenience and efficiency. In an embodiment, the charcoal supply consists of a dedicated compartment built into the housing that holds charcoal, allowing for easy loading without the need for separate storage. The compartment is positioned within the chamber and is configured to securely contain the charcoal, preventing spillage when the apparatus is moved or tilted. Additionally, there are starter compartments positioned adjacent to the charcoal supply. These compartments are designed to hold starter materials, including, but not limited to, firelighters and/or paraffin cubes, which are used to ignite the charcoal. The starter compartments are placed to ensure that the starters are easily accessible and properly positioned to facilitate an efficient lighting process, ensuring that the charcoal ignites quickly and evenly.

In some aspects, the techniques described herein relate to a chimney starter kit, including: a chimney apparatus including: a housing having at least one side wall forming a chamber, the housing including: an opening bordering an outer perimeter edge of the chamber; and a base plate located opposite the opening; a support structure connected to an outer wall surface of the at least one side wall of the housing; a first handle hingedly pivotal at a fulcrum point; and a barrier element disposed at a surface of the support structure; a starter material retained in the chamber of the housing of the chimney apparatus; and a charcoal supply retained in the chamber of the housing of the chimney apparatus.

In some aspects, the techniques described herein relate to a chimney starter kit, wherein the housing is hexagonal in shape.

In some aspects, the techniques described herein relate to a chimney starter kit, wherein the first handle protruding from the outer wall surface of the at least one side wall of the housing.

In some aspects, the techniques described herein relate to a chimney starter kit, further including: a second handle is hingedly pivotal at a fulcrum point, the first handle is oriented perpendicular to the second handle.

In some aspects, the techniques described herein relate to a chimney starter kit, wherein the first handle and the second handle are both connected to a mounting structure, the mounting structure connected to the barrier element.

In some aspects, the techniques described herein relate to a chimney starter kit, wherein the base plate has one or more bores.

In some aspects, the techniques described herein relate to a chimney starter kit, wherein the at least one side wall has one or more openings.

In some aspects, the techniques described herein relate to a chimney starter kit, further including a first opening of the one or more openings being in coplanar alignment with a second opening of the one or more openings.

In some aspects, the techniques described herein relate to a chimney starter kit, wherein the barrier element has one or more beveled edges.

In some aspects, the techniques described herein relate to a chimney starter kit, further including a first beveled edge of the one or more beveled edges extends beyond an outer perimeter edge of the support structure.

In some aspects, the techniques described herein relate to a chimney starter kit, further including a second beveled edge of the one or more beveled edges is located opposite the first beveled edge.

In some aspects, the techniques described herein relate to a chimney starter kit, including: a chimney apparatus, including: a housing having at least one side wall forming a chamber, the housing including: an opening bordering an outer perimeter edge of the chamber; and a base plate located opposite the opening; a support structure connected to an outer wall surface of the at least one side wall of the housing; a barrier element disposed at a surface of the support structure; a mounting structure connected to a plate of the barrier element; and a first handle hingedly pivotal at a fulcrum point connected to the mounting structure; a starter material retained in the chamber of the housing of the chimney apparatus; and a charcoal supply retained in the chamber of the housing of the chimney apparatus.

In some aspects, the techniques described herein relate to a chimney starter kit, wherein the housing is hexagonal in shape.

In some aspects, the techniques described herein relate to a chimney starter kit, further including: a second handle is hingedly pivotal at a fulcrum point, the first handle is oriented perpendicular to the second handle.

In some aspects, the techniques described herein relate to a chimney starter kit, wherein the first handle and the second handle are both connected to the mounting structure.

In some aspects, the techniques described herein relate to a system, including: a chimney apparatus, including: a housing having at least one side wall forming a chamber, the housing including: an opening bordering an outer perimeter edge of the chamber; and a base plate located opposite the opening; a support structure connected to an outer wall surface of the at least one side wall of the housing; a first handle hingedly pivotal at a fulcrum point; and a barrier element disposed at a wall surface of the support structure; a starter material retained in the chamber of the housing of the chimney apparatus; and a charcoal supply retained in the chamber of the housing of the chimney apparatus.

In some aspects, the techniques described herein relate to a system, wherein the housing is hexagonal in shape.

In some aspects, the techniques described herein relate to a system, wherein the first handle protruding from the outer wall surface of the at least one side wall of the housing.

In some aspects, the techniques described herein relate to a system, further including: a second handle is hingedly pivotal at a fulcrum point, the first handle is oriented perpendicular to the second handle.

In some aspects, the techniques described herein relate to a system, wherein the first handle and the second handle are both connected to a mounting structure, the mounting structure is connected to an outer wall surface of the barrier element.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A chimney starter kit, comprising:
a chimney apparatus comprising:
a housing having at least one side wall forming a chamber, the housing comprising:
an opening bordering an outer perimeter edge of the chamber; and
a base plate located opposite the opening;
a support structure connected to an outer wall surface of the at least one side wall of the housing;
a first handle hingedly pivotal at a fulcrum point; and
a barrier element disposed at a surface of the support structure;
a starter material retained in the chamber of the housing of the chimney apparatus; and
a charcoal supply retained in the chamber of the housing of the chimney apparatus.

2. The chimney starter kit of claim 1, wherein the housing is hexagonal in shape.

3. The chimney starter kit of claim 1, wherein the first handle protruding from the outer wall surface of the at least one side wall of the housing.

4. The chimney starter kit of claim 3, further comprising:
a second handle is hingedly pivotal at a fulcrum point, the first handle is oriented perpendicular to the second handle.

5. The chimney starter kit of claim 4, wherein the first handle and the second handle are both connected to a mounting structure, the mounting structure connected to the barrier element.

6. The chimney starter kit of claim 1, wherein the base plate has one or more bores.

7. The chimney starter kit of claim 1, wherein the at least one side wall has one or more openings.

8. The chimney starter kit of claim 7, further comprising a first opening of the one or more openings being in coplanar alignment with a second opening of the one or more openings.

9. The chimney starter kit of claim 1, wherein the barrier element has one or more beveled edges.

10. The chimney starter kit of claim 9, further comprising a first beveled edge of the one or more beveled edges extends beyond an outer perimeter edge of the support structure.

11. The chimney starter kit of claim 10, further comprising a second beveled edge of the one or more beveled edges is located opposite the first beveled edge.

12. A chimney starter kit, comprising:
a chimney apparatus, comprising:
a housing having at least one side wall forming a chamber, the housing comprising:
an opening bordering an outer perimeter edge of the chamber; and
a base plate located opposite the opening;
a support structure connected to an outer wall surface of the at least one side wall of the housing;
a barrier element disposed at a surface of the support structure;
a mounting structure connected to a plate of the barrier element; and
a first handle hingedly pivotal at a fulcrum point connected to the mounting structure;
a starter material retained in the chamber of the housing of the chimney apparatus; and
a charcoal supply retained in the chamber of the housing of the chimney apparatus.

13. The chimney starter kit of claim 12, wherein the housing is hexagonal in shape.

14. The chimney starter kit of claim 12, further comprising:
a second handle is hingedly pivotal at a fulcrum point, the first handle is oriented perpendicular to the second handle.

15. The chimney starter kit of claim 14, wherein the first handle and the second handle are both connected to the mounting structure.

16. A system, comprising:
a chimney apparatus, comprising:
a housing having at least one side wall forming a chamber, the housing comprising:
an opening bordering an outer perimeter edge of the chamber; and
a base plate located opposite the opening;
a support structure connected to an outer wall surface of the at least one side wall of the housing;
a first handle hingedly pivotal at a fulcrum point; and
a barrier element disposed at a wall surface of the support structure;
a starter material retained in the chamber of the housing of the chimney apparatus; and
a charcoal supply retained in the chamber of the housing of the chimney apparatus.

17. The system of claim 16, wherein the housing is hexagonal in shape.

18. The system of claim 16, wherein the first handle protruding from the outer wall surface of the at least one side wall of the housing.

19. The system of claim 18, further comprising:
a second handle is hingedly pivotal at a fulcrum point, the first handle is oriented perpendicular to the second handle.

20. The system of claim 19, wherein the first handle and the second handle are both connected to a mounting structure, the mounting structure is connected to an outer wall surface of the barrier element.
